(19) United States
(12) Patent Application Publication
(10) Pub. No.: US 2010/0323758 A1
(43) Pub. Date: Dec. 23, 2010

(54) COMMUNICATION DEVICE AND CONTROL METHOD THEREOF

(75) Inventor: Ryosuke Amano, Funabashi-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/772,057

(22) Filed: Apr. 30, 2010

(30) Foreign Application Priority Data
Jun. 17, 2009 (JP) 2009-144612

(51) Int. Cl. H04B 1/38

(52) U.S. Cl. 455/557

(57) ABSTRACT

A communication device having a display control determining unit configured to evaluate a display form of a display unit to determine a type of display form, a selecting unit configured to select a service corresponding to the type of display form determined by the display control determining unit, and a communication unit configured to establish a communication with a partner device by using the service selected by the selecting unit.

### BACKGROUND OF THE INVENTION

1. Field of the Invention

The present invention relates to a communication device for carrying out a cooperation service between devices, a control method of the communication device and a program.

2. Description of the Related Art

When devices cooperatively carry out a service (i.e., a cooperation service), it is necessary to define information necessary for carrying out the cooperation service. For example, Japanese Patent Laid-open Publication No. 2004-9388 discusses a method in which, when a digital camera and a printer are directly connected to each other and a print service is realized between the digital camera and the printer, a user sets extension information such as a size or a quality of a print sheet. Further, in a case of an infrared data communication of a cell-phone, the user designates settings on a sending side and a receiving side, and data to be transferred.

Recently, information items to be defined to carry out the cooperation service (e.g., types of services, applications, protocols, and service defining information) have been increasing due to the increased number of the cooperation services. Therefore, the user has to carry out defining operations for many items, i.e., operations of the service user are becoming more intricate. As a result, the number of operating errors is increasing and thus there are cases that the user unintentionally uses a service different from the cooperation service the user desires or that the user cannot use the cooperation service.

### SUMMARY OF THE INVENTION

According to an aspect of the present invention, a communication device includes a display control determining unit configured to evaluate a display form of a display unit to determine a type of display form, a selecting unit configured to select a service corresponding to the type of display form determined by the display control determining unit, and a communication unit configured to establish a communication with a partner device by using the service selected by the selecting unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a system configuration.

FIGS. 2A and 2B, respectively, are block diagrams illustrating functions of a communication device.

FIG. 3 is a flow chart illustrating an operation of a digital camera.

FIG. 4 is a schematic view illustrating service information.

FIG. 5 is an example of a configuration of a service information storage table.

FIG. 6 illustrates a system configuration.

FIG. 7 is a flow chart illustrating an operation of a digital camera.

FIG. 8 is a schematic view illustrating service information.

FIG. 9 is an example of a configuration of a service information storage table.

FIGS. 10A and 10B, respectively, are an example of a display of a selection menu.

FIG. 11 is a flow chart illustrating an operation of the digital camera.

### DESCRIPTION OF THE EMBODIMENTS

Various exemplary embodiments, features, and aspects of the invention will be described in detail below with reference to the drawings.

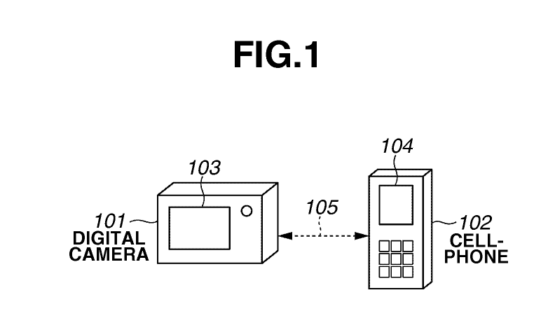

FIG. 1 illustrates a configuration of a system according to a first exemplary embodiment. The system includes a digital camera 101 and a cell-phone 102. The cell-phone 102 is a communication partner of the digital camera 101. A display unit is an electronic device that represents information in visual form. The digital camera 101 includes a display unit 103 and the cell-phone 102 includes a display unit 104, respectively. An operator of the digital camera 101 and the cell-phone 102 can change or set a display form, e.g., can browse or select an image file, while viewing display screens of the display units 103 and 104. The digital camera 101 and the cell-phone 102, respectively, include a computer (CPU—Central Processing Unit) for controlling the device and a memory for storing a program executed by the computer.

The digital camera 101 is connected to the cell-phone 102 through a proximal wireless communication 105 when the digital camera 101 is moved closer to the cell-phone 102, so that a peer-to-peer communication can be established between the digital camera 101 and the cell-phone 102 through the proximal wireless communication 105. Examples of the proximal wireless communication 105 include a non-contact type IC card wireless communication and a Near Field Communication (NFC), which use an electromagnetic induction and a communication using an induction field. In the proximal wireless communication 105, a communication can be established when the devices are placed within a range of a distance of a few centimeters therebetween.

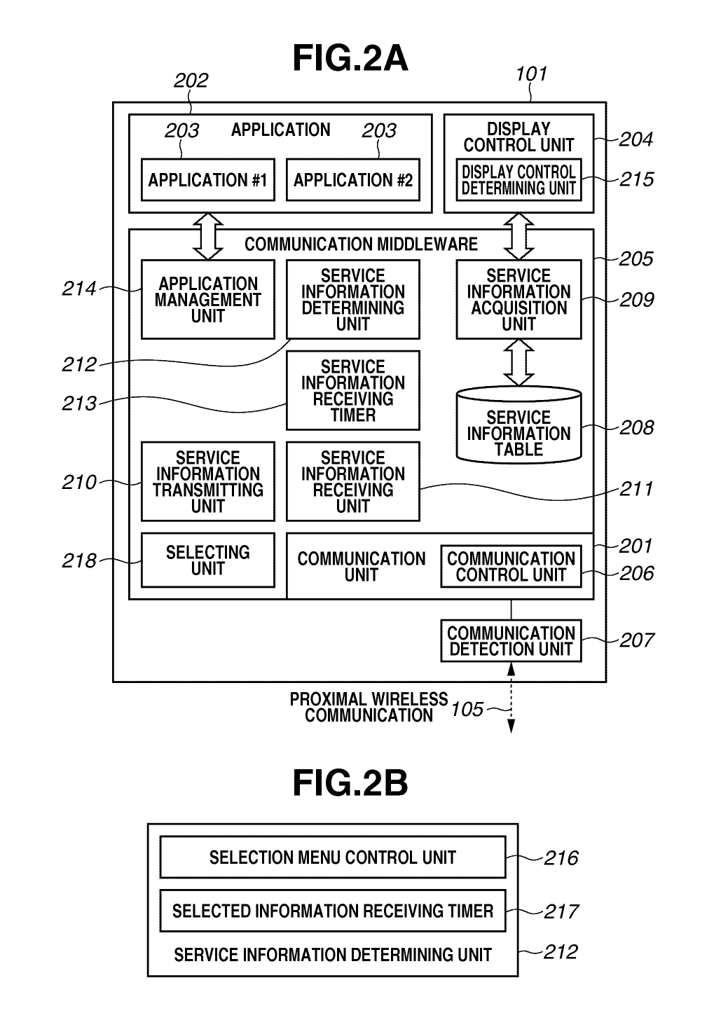

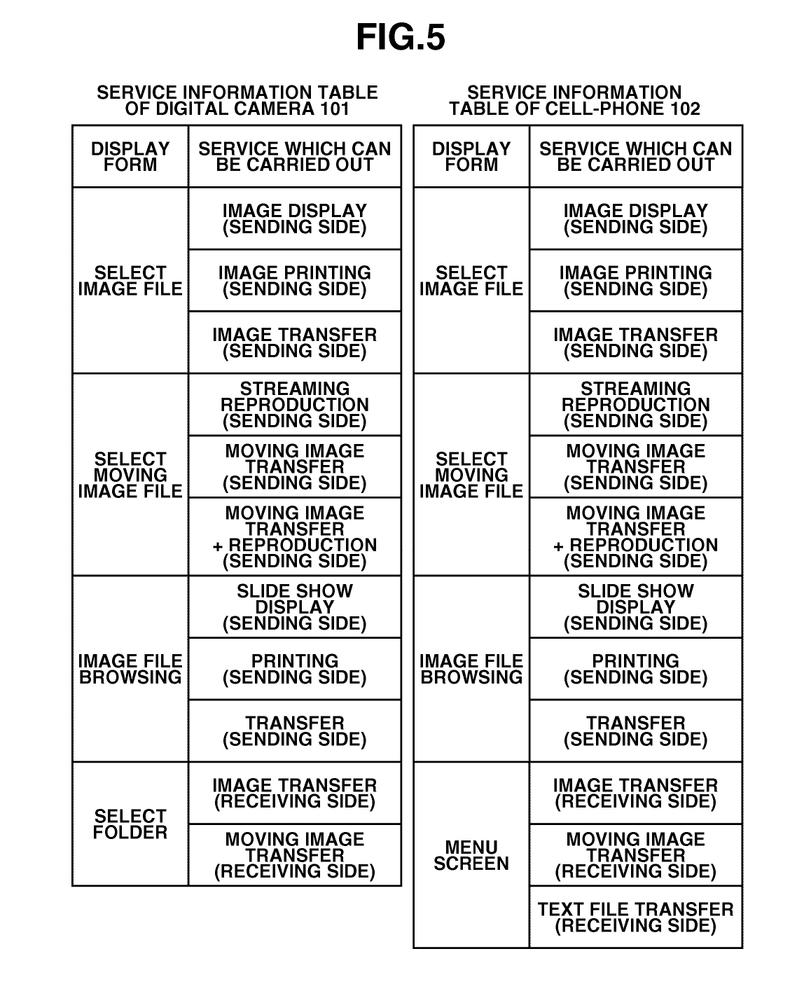

FIGS. 2A and 2B, respectively, are block diagrams illustrating a configuration of each of the digital camera 101 and the cell-phone 102. The configurations of FIGS. 2A and 2B can be realized by the computer (CPU) of the digital camera 101, the cell-phone 102, and the below-mentioned digital camera 601 executing a program. FIG. 2B will be described below as a second exemplary embodiment. A communication unit 201 establishes the proximal wireless communication 105 of FIG. 1. An application 202 is included in the device and application program 203 provides services such as image printing and a video replay. A display control unit 204 controls display forms of the display unit 103 and 104. The display control unit 204 includes a display control determining unit 215 that evaluates display forms of the display units 103 and 104 such as by distinguishing between display forms. Examples of the types of display forms of the display units 103 and 104 include a browsing form, a graphical user interface selecting form of a directory, a file, and a service, and others listed in FIG. 5. The display control unit 204 holds detailed information relating to the directory, the file, and the service, e.g., holds metadata such as a file name and a file expansion.

A communication middle ware unit 205 provides a control function to control the communication unit 201 and a selecting function to select a service to be carried out. A communication control unit 206 controls the proximal wireless communication 105. A communication detection unit 207 controls and detects a connection or a disconnection of the proximal wireless communication 105. The communication detection unit 207 detects connection with a second/partner device, where the partner device is a communication partner capable of establishing a communication through the proximal wireless communication 105 when the partner device comes into an area of the proximal wireless communication 105. On the other hand, when the partner device is moved away from the area of the proximal wireless communication 105, the communication detection unit 207 detects the disconnection with the partner device. A selecting unit 218 of the communication middle ware unit 205 selects a service corresponding to the display form determined by the display control determining unit 215. The selecting unit 218 performs processing to select an item of the service information in a case where the service to be used can be determined automatically. The selecting unit 218 may select a service corresponding to a display form on the display unit 103 when the communication detection unit 207 detects a connection with a partner device. The partner device provides information relating to the service to be carried out. The selecting unit 218 selects the service corresponding to the display form based on the information managed by an application management unit 214.

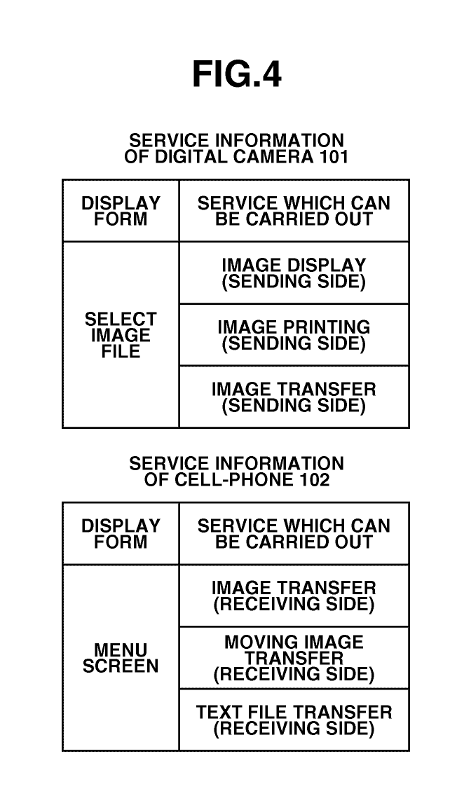

A service information table 208 holds therein service information defined for each of the display forms of the display units 103 and 104. The service information table 208 is stored in each of the storage units of the digital camera 101 and the cell-phone 102. The stored service information includes the kinds of services that can be carried out in a certain display form. The service information includes, for example, a list of services such as image printing services and an image transfer services as illustrated in FIG. 4. The service information table 208 holds the service information for each of the type of display forms as illustrated in FIG. 5. More specifically, the service information table 208 is described in the form of an Extensible Markup Language (XML language).

A service information acquisition unit 209 acquires service information from the service information table 208 corresponding to the display form that was requested from the display control unit 204. A service information transmitting unit 210 transmits the service information acquired by the service information acquisition unit 209 to a partner device as a connection destination through the proximal wireless communication 105. A service information receiving unit 211 receives the service information from the partner device. A service information determining unit 212 compares service information of the own/immediate/sending/source device with service information of the partner/remote/receiving/target device to determine a service to be carried out. A service information receiving timer 213 measures the time it takes for the service information of the partner device to be received by the service information receiving unit 211. In a case where the service information is not received before a predetermined time period has lapsed, no determination of service is performed by the service information determining unit 212 and the processing is ended. An application management unit 214 activates application program 203, where the application program 203 provides the service determined by the service information determining unit 212.

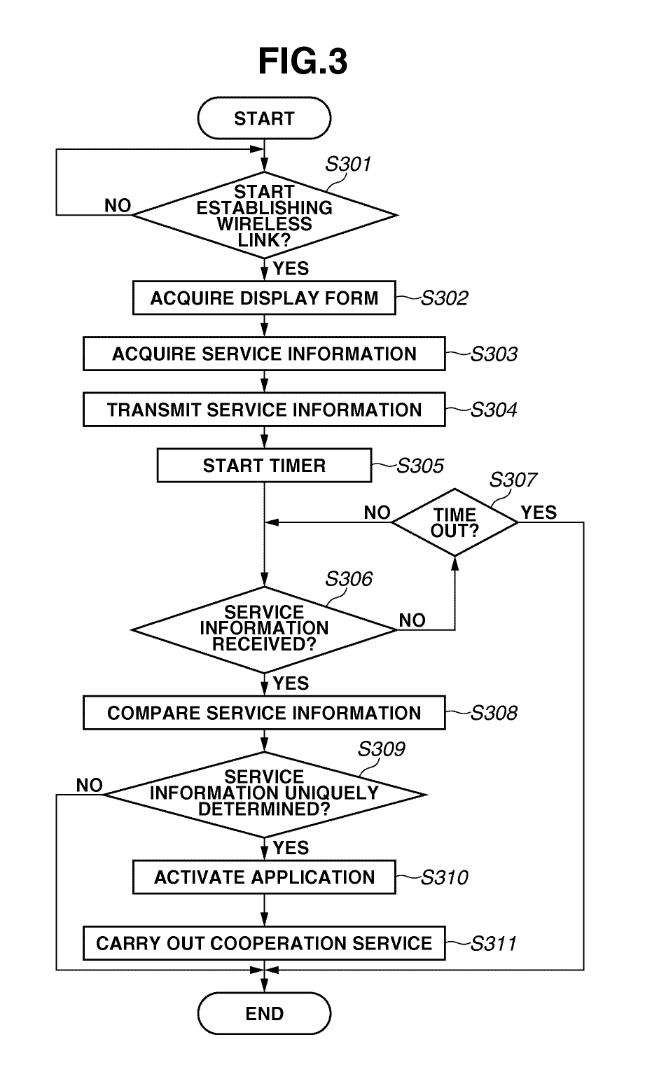

Hereinafter, an operation of the present exemplary embodiment is described with reference to an operational flow chart of FIG. 3. In the following description, the digital camera 101 is dealt with. More specifically, in the description, the digital camera 101 (sending side) is defined as an own device, and the cell-phone 102 (receiving side) is defined as a partner device, respectively. However, the both of the own device and the partner device are interchangeable in performing the operation, regardless of which is the own device and which is the partner device.

In an initial state, the digital camera 101 is placed sufficiently far from the cell-phone 102 so that communication cannot be established between the digital camera 101 and the cell-phone 102 through the proximal wireless communication 105. In a case where the operator desires to transfer an image file stored in the digital camera 101 to the cell-phone 102, the operator operates the digital camera 101 to select the image file the operator desires to transfer. Normally, the operator causes the display unit 103 of the digital camera 101 to display the image file which the operator desires to transfer. In comparison, the operator causes the display unit 104 of the cell-phone 102 to display a menu screen.

In this state, the digital camera 101 is brought closer to the cell-phone 102 so that the cell-phone 102 may become a communication partner with the digital camera 101. In step S301, the operation determines whether the communication detection unit 207 in the digital camera 101 detects a connection to the proximal wireless communication 105 since the communication detection unit 207 monitors the connection of the proximal wireless communication 105. A purpose of this determination is to start establishing a wireless link. If the communication detection unit 207 does not detect a connection to the proximal wireless communication 105, the operational flow returns to step S301. In a case where the communication detection unit 207 detects the connection (YES in step S301), the display control determining unit 215 studies the display form of the display unit 103 to determine a type of display form and notifies the derived result to the service information acquisition unit 209. In the example, the operator caused the display unit 103 of the digital camera 101 to display the image file which the operator desires to transfer. In step S302, the service information acquisition unit 209 acquires the display form of the display unit 103 at the time according to the notification from the display control determining unit 215.

As a result of the above, in step S303, the service information acquisition unit 209 can confirm that the image file is selected in the display form, and thus the service information acquisition unit 209 detects and acquires from the service information table 208 the particular service information that corresponds to the display form. Since the display form represents that the image file is selected here, the service information acquisition unit 209 acquires an image display (sending side), image printing (sending side) and an image transfer (sending side) as the service information (see FIGS. 4 and 5). In other words, the service information acquisition unit 209 looks up “select image file” in the Service Information Table of Digital Camera 101 in FIG. 5 to obtain as service information those services that can be carried out based on the “select image file” display form.

In step S304, the service information transmitting unit 210 transmits from the own device to the partner device the service information that the service information acquisition unit 209 acquired. In this example, the service information transmitting unit 210 transmits the service information from the digital camera 101 as the own device to the cell-phone 102 as the partner device. This transfer of own device service information to the partner device makes the partner device aware of those services that can be carried out based on the display form of the own device. In step S305, the service information transmitting unit 210 activates the service information receiving timer 213 of the own device. Timely receipt of partner device service information affects the cooperation service. In step S306, the operation determines whether the partner device service information has been received. In a case where the partner device service information is not received from the partner device, the operation proceeds to step S307 to determine whether a predetermined time period has lapsed after the activation of the service information receiving timer 213 in step S305. If a predetermined time period has lapsed after the activation of the service information receiving timer 213 in step S305, then it is determined that an abnormal incident has occurred in the partner device or that the partner device is a legacy device which does not perform the present processing, so that the service selecting processing is stopped and ended. If a predetermined time period has not lapsed after the activation of the service information receiving timer 213 in step S305, then the operation returns to step S306. In step S306, in a case where the service information receiving unit 211 receives the service information from the cell-phone 102 (YES in step S306), the service information receiving timer 213 is stopped and the operation proceeds to step S308.

The services that can be carried out by the partner device under the circumstances may or may not match the services that can be carried out by the own device. In step S308, the service information determining unit 212 compares the service information of the own device, which the service information acquisition unit 209 acquired in step S303, with the received service information of the cell-phone 102. In other words, the service information determining unit 212 compares the own device service information and the partner device service information at step S708. In step S309, as a result of the comparison in step S308, it is determined whether or not there is the service information that is operated through cooperation. In other words, at step S309, the operation determines within the own device 101 whether there is one common service from the comparison at step S308 that can be performed by both the own device 101 and the partner device 102. That is to say, the operation determines whether the acquired own device service information and the acquired partner device service information is uniquely determined by not having more than or less than one service information in common. Since the display of the cell-phone 102 represents a menu screen in this example, that partner device display form corresponds to an image transfer (receiving side), a moving image transfer (receiving side) and a text file transfer (receiving side) per the Service Information Table of Cell-phone 102 in FIG. 5. Thus, the service information receiving unit 211 receives from Cell-phone 102 at step S306, an image transfer (receiving side), a moving image transfer (receiving side) and a text file transfer (receiving side) partner device service information. Thus, between the three services of the own device service information and the three services of the partner device service information, there is one common service: image transfer. Therefore, in step S309, the image transfer (sending side) corresponds to the image transfer (receiving side) as the service information to be operated through cooperation and the image transfer service is determined as the service to be used here.

In step S310, the application management unit 214 activates application program 203, which provides a cooperation service (image transfer service) determined by the service information determining unit 212 at step S309. In step S311, thus determined cooperation service (image transfer service) is carried out by the activated application program 203, after which the processing is stopped and terminated.

Application program 203, which provides the image transfer service, is activated to perform the same processing both in the cell-phone 102 as the partner device and in the digital camera 101 as the own device. In other words, the applications of the image transfer service corresponding to each of the digital camera 101 and the cell-phone 102 are operated in both of the devices (i.e., the digital camera 101 and the cell-phone 102), and the image file selected by the digital camera 101 is transferred to the cell-phone 102.

Further, in step S309, in a case where there is no corresponding service information or in a case where there are a plurality of pieces of the corresponding service information and thus the service information cannot be uniquely determined (NO in step S309) as a result of the comparison performed in step S308, the service information determining unit 212 stops and ends the service selecting processing.

As described above, if the operator selects the image file in the display unit 103 of the digital camera 101 and causes the cell-phone 102 to display the menu screen, the image file can be transferred only when the operator brings the digital camera 101 into contact with (closer to) the cell-phone 102. Further, in a case where the abnormal incident occurs in the partner device or in a case where the partner device is the legacy device, the processing can be ended without causing a malfunction. In a case where the service information cannot be uniquely determined, operator can terminate the processing without implementing the service, which the user does not intend to be carried out, to be carried out. In this case, the operator can use the service the operator desires by performing the operation to determine the service information to be used, in both of the digital camera 101 and the cell-phone 102.

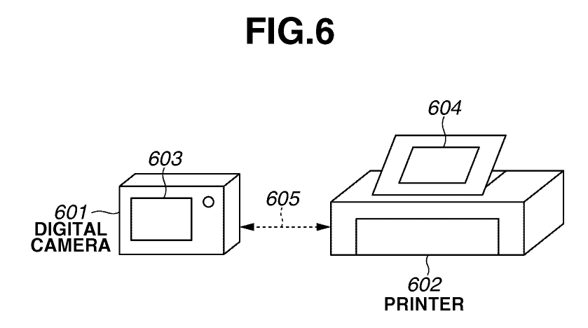

FIG. 6 illustrates a system configuration according to a second exemplary embodiment. The system includes a digital camera 601 and a printer 602. The printer 602 is a communication partner of the digital camera 601. The digital camera 601 includes a display unit 603 and the printer 602 includes a display unit 604. An operator of the digital camera 601 and the printer 602 can change or set the display form, i.e., browse or select the image file, while viewing the displays of the display unit 603 and 604. The digital camera 101 and the digital camera 601, respectively, include a computer (CPU) for controlling the device and a memory for storing a program to be executed by the computer. In a proximal wireless communication 605, a peer-to-peer communication can be established through the proximal wireless communication 605 when digital camera 601 is brought closer to the printer 602.

The block diagram of FIG. 2 also illustrates configurations of the digital camera 601 and the printer 602, respectively. In the present exemplary embodiment, the service information determining unit 212 has a configuration as illustrated in FIG. 2B. Parts of the configuration different from the first exemplary embodiment are described below.

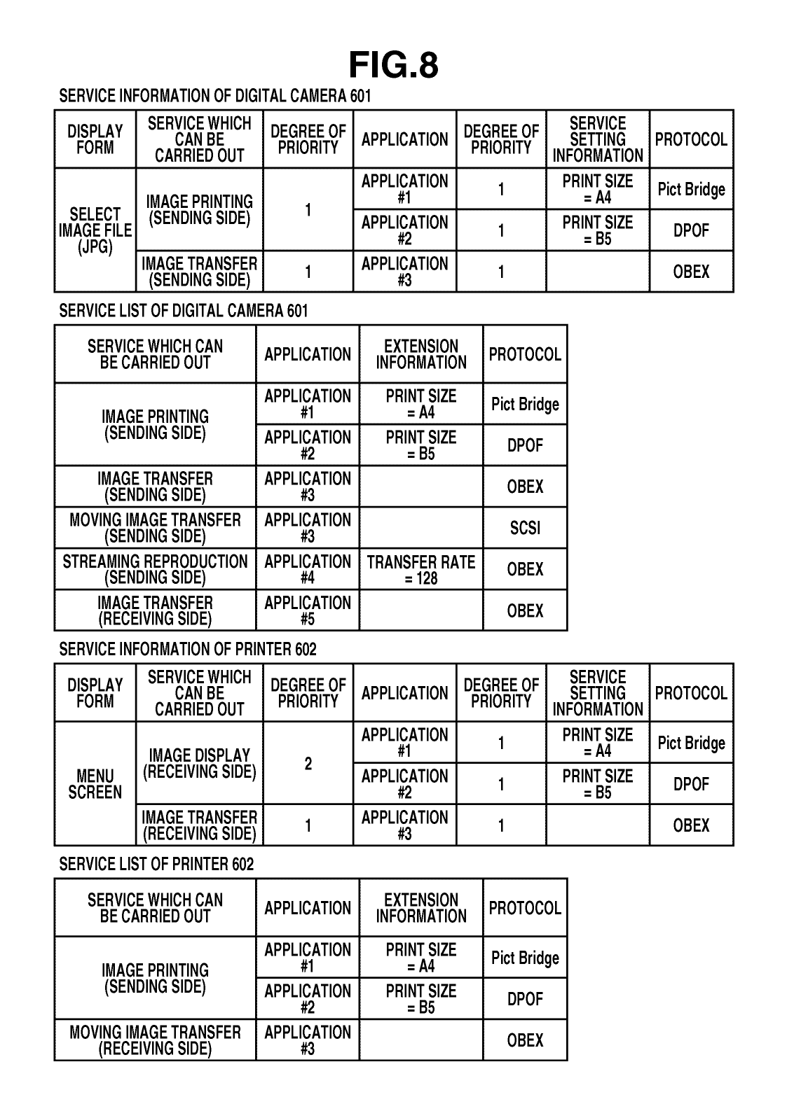

The service information described in the present exemplary embodiment includes an application necessary for carrying out the service, service setting information, a communication protocol (hereinafter referred to as the “protocol”) and items representing a degree of a priority of each of the above in addition to kinds of services which can be carried out in a certain display form (FIG. 8). However, the priority is not necessarily assigned, but a default value, which is preliminarily set, is automatically assigned to the items showing no priority.

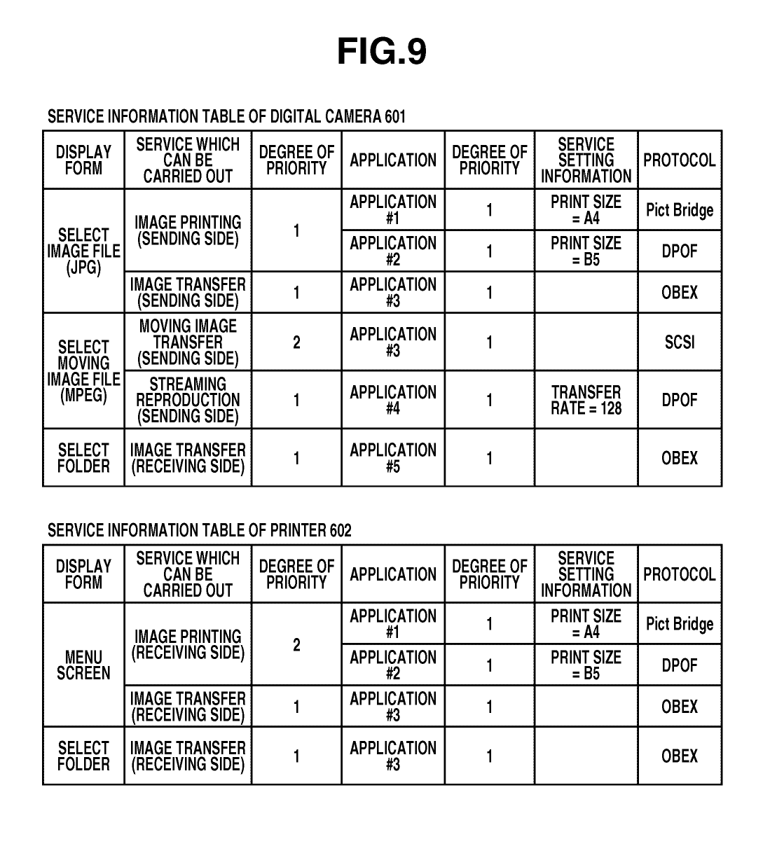

The service information table 208 holds service information for the respective display forms as illustrated in FIG. 9. The service information table 208 holds various kinds of services which can be carried out by the own device, applications, service setting information, and protocols which are required for the services in such a manner that they correspond to and are associated with the services. The information managed by the service information table 208 is not necessarily all the pieces of the information as mentioned above, but may be one or more than one pieces of the above-described information.

The service information acquisition unit 209 (FIG. 2A) acquires the display form from the display control unit 204 and further acquires service information and service list corresponding to the display form from the service information table 208. The service information transmitting unit 210 transmits the own device service information and the service list to the partner device. The service information receiving unit 211 receives in the own device the partner device service information and the service list from the partner device.

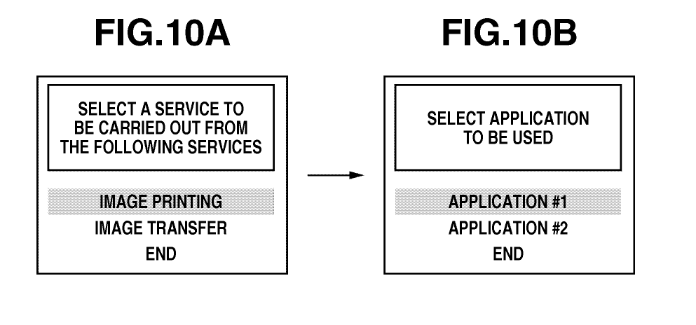

The service information determining unit 212 includes a selection menu control unit 216 (FIG. 2B) and a selected information receiving timer 217. As noted, the selecting unit 218 (FIG. 2A) performs processing to select an item of the service information in a case where the service to be used can be determined automatically. In contrast, the selection menu control unit 216 (FIG. 2B) performs processing for causing the operator to select an item of the service information in a case where the service to be used could not be determined automatically. More specifically, as illustrated in FIG. 10, the items that could not be determined are displayed on the display units 603 and 604 in the form of a list according to a control of the display control unit 204, and a process is carried out to cause the human operator to select and determine the item of the service information. Thus determined service information is transmitted to the partner device through the service information transmitting unit 210. Alternatively, it is also possible to determine the service information by receiving thus determined service information from the partner device 602.

The selected information receiving timer 217 measures the time it takes for the service information to be received from the partner device 602. The selected information receiving timer 217 is activated when the selection menu is displayed on each of the display units 603 and 604 by the selection menu control unit 216, whereas the selected information receiving timer 217 is stopped when the service information is determined. While the service information receiving timer 213 (FIG. 2A) is activated in a case where the service to be used can be determined automatically, the selected information receiving timer 217 (FIG. 2B) is activated in a case where the service to be used can not be determined automatically.

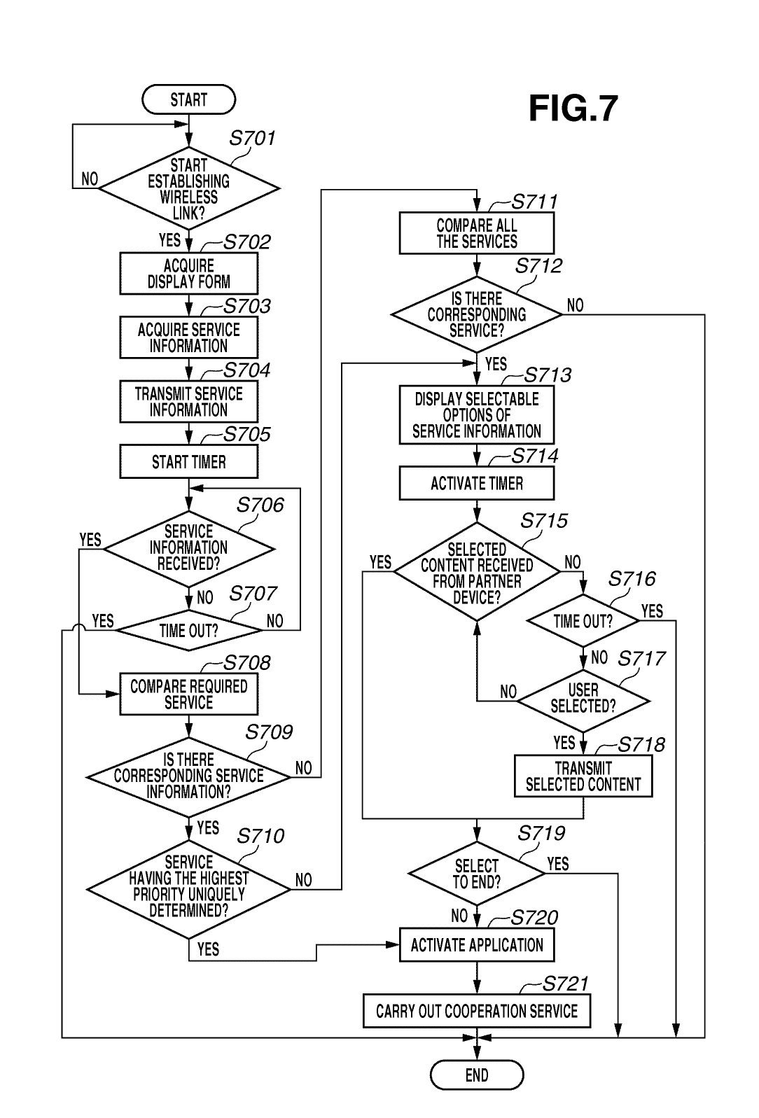

An operation of the present exemplary embodiment is described below with reference to an operational flow chart of FIG. 7. The second exemplary embodiment deals with the digital camera 601 and thus in the description, the digital camera 601 (sending side) is the own device and the printer 602 (receiving side) is the partner device. However, the both of the own device and the partner device are interchangeable and similarly operate, regardless of which is the own device and which is the partner device.

In an initial state, the digital camera 601 is placed sufficiently far from the printer 602 so that communication cannot be established between the digital camera 601 and the printer 602 through the proximal wireless communication 605. In a case where the operator desires to print an image file stored in the digital camera 601 by using the printer 602, the operator selects the image file the operator desires to print through an operation of the digital camera 601. Normally, the operator may only cause the display unit 603 of the digital camera 601 to display an image of the image file. In comparison, the operator sets the display unit 604 of the printer 602 to a menu screen.

In this state, the digital camera 601 is brought closer to the printer 602 so that the printer 602 may become a communication partner with the digital camera 601. In step S701, the operation determines whether the communication detection unit 207 in the digital camera 601 detects a connection to the proximal wireless communication 605. A purpose of this determination is to start establishing a wireless link. If the communication detection unit 207 does not detect a connection to the proximal wireless communication 605, the operational flow returns to step S701. In a case where the communication detection unit 207 detects the connection (“YES in step S701), the display control determining unit 215 evaluates the display form of the display unit 603 to notify the determined result to the service information acquisition unit 209. In the example, the operator caused the display unit 603 of the digital camera 601 to display an image of the image file. In step S702, the service information acquisition unit 209 acquires the display form of the display unit 603 at the time according to the notification from the display control determining unit 215.

As a result, in step S703, the service information acquisition unit 209 can confirm that the image file is selected in the display form, can detect the service information table 208, and can acquire the service information corresponding to the display form. Since the image file is selected in the display here, image printing (sending side) and an image transfer (sending side) are acquired as the service information (see FIGS. 8 and 9). In other words, the service information acquisition unit 209 looks up “select image file (JPG) ” in the Service Information Table of Digital Camera 601 in FIG. 9 to obtain as service information those services that can be carried out based on the “select image file (JPG)” display form.

In step S704, the service information transmitting unit 210 transmits from the own device to the printer 602 partner device the service information that the service information acquisition unit 209 acquired. This transfer of own device service information to the partner device makes the partner device aware of those services that can be carried out based on the display form of the own device. In step S705, the service information transmitting unit 210 activates the service information receiving timer 213 of the own device. Timely receipt of partner device service information affects the cooperation service. In steps 5706, the operation determines whether the partner device service information has been received. In a case where the service information is not received from the partner device, the operation proceeds to step S707 to determine whether a predetermined time period has lapsed after the service information receiving timer 213 was activated in step S707), S705. If a predetermined time period has lapsed after the activation of the service information receiving timer 213 in step S705, then the service selecting processing is stopped and terminated. Examples of why the predetermined time period has lapsed include a determination that the abnormal incident has occurred in the partner device or that the partner device is a legacy device which cannot perform the present processing. If a predetermined time period has not lapsed after the activation of the service information receiving timer 213 in step S705, then the operation returns to step S706. In step S706, in a case where the service information receiving unit 211 received the service information from the partner device (YES in step S706), the service information receiving timer 213 is stopped and the operation proceeds to step S708.

The services that can be carried out by the partner device under the circumstances may or may not match the services that can be carried out by the own device. In step S708, the service information determination unit 212 compares the service information of the own device, which the service information acquisition unit 209 acquired in step S703, with the service information of the cell-phone 602, which the service information receiving unit 211 received in step S706. In other words, the service information determining unit 212 compares the own device service information and the partner device service information at step S708. In step S709, as a result of the comparison in step S708, the operation determines whether or not there is the service information for cooperation service. In other words, at step S709, the operation determines within the own device 601 whether there is any common service from the comparison at step S708 that can be performed by both the own device 601 and the partner device 602. That is to say, the operation determines whether the acquired own device service information and the acquired partner device service information corresponds by having at least one service information in common. Since the display of the printer 602 represents a menu screen in this example, that partner device display form corresponds to an image printing (receiving side) and an image transfer (receiving side) per the Service Information Table of Printer 602 in FIG. 9. Thus, the service information receiving unit 211 receives from the printer 602, an image printing (receiving side) and an image transfer (receiving side) partner device service information. Thus, between the two services of the own device service information and the two services of the partner device service information, there are two common service. In other words, the image printing (sending side) corresponds to the image printing (receiving side), and the image transfer (sending side) corresponds to the image transfer (receiving side), respectively, as the service information which operates in cooperation with each other.

When the operation finds in step S709 at least one service information shared by both the own device and the partner device for the given display forms, the operation proceeds to step S710. In step S710, the operation determines the service information having the highest priority uniquely determined. To make the determination in step S710, a comparison is made between the sum of the degrees of the priorities of the own device and the sum of the degrees of the priorities of the partner device with respect to each item relating to the services to determine the service having the largest sum of the priorities, as the service to be carried out in step S721. In step S710, in a case where there is only one corresponding service with respect to all the items, the service is determined as the service to be carried out regardless of the degree of the priority. From step S710, the operation proceeds to step S720. In step S720, the application management unit 214 activates application program 203, which is determined by the service information determining unit 212 in order to provide the cooperation service. In step S721, the thus determined cooperation service is carried out by the activated application program, after which the service selecting processing is stopped and terminated.

As in FIG. 9, particular services which can be carried out include a degree of priority. In the second exemplary embodiment, the sum of the degrees of the priorities of the image printing service is three and the sum of the degrees of priority of the image transfer service is two. Since the degree of the priority (the sum of the degrees of the priorities) of the image printing service is higher than the degree of the priority of the image transfer service, the service to be carried out at step S721 is uniquely determined at step S710 to be the image printing service. As noted, the determination made at step S710 also compares the sum of the degrees of priority for the application. In the present example, with respect to the application necessary in carrying out the service, since the degree of the priority of the application #1 (see FIG. 9) and the degree of the priority of the application #2 (see FIG. 9) are equal to each other, service information cannot be uniquely determined at step S710. If the operation determines at step S710 that the service information having the highest priority cannot be uniquely determined, the operation proceeds to step S713. Recall that the selecting unit 218 (FIG. 2A) performs processing to select an item of the service information in a case where the service to be used can be determined automatically. In contrast, the selection menu control unit 216 (FIG. 2B) performs processing for causing the operator to select an item of the service information in a case where the service to be used could not be determined automatically. In step S713, in a case where the service information cannot be determined, the selection menu control unit 216 displays the service information that could not be determined in the display unit 603 as an option and thereby encourages the human operator to determine the service the operator desires to use. In step S714, the selected information receiving timer 217 is activated. Here, for example, a menu of FIG. 10A or 10B is displayed and a selection of the service information in either one of the own device or the partner device is waited.

In step S715, the operation determines whether operator selected content/service information is received in the own device from the partner device. If the operator selected content/service information has not been received in the own device, the operation determines at step S716 whether a predetermined time period has lapsed based on the selected information receiving timer 217 activated in step S714. If the predetermined time period has lapsed (YES at step S716), the process ends. In other words, if the service information is not selected in the own device and the service information selected by the partner device is not received before the selected information receiving timer 217 measures the predetermined time period (YES in step S716), the processing is ended. If the predetermined time period has not lapsed (NO at step S716), the operation proceeds to step S717. In step S717, in a case where the operator does not operate the digital camera 601 to select the service information and determine the service (No in step S717), the operation returns to step S715. In step S717, in a case where the operator operates the digital camera 601 to select the service information and determine the service (Yes in step S717), the operation proceeds to step S718. In step S718, the service information determined by the service information transmitting unit 210 is transmitted and the operation proceeds to step S719. In step S715, also in a case where the operator performs the determination operation of the service information in the printer 602 as the partner device and the service information receiving unit 211 receives the service information determined by the partner device (YES in step S715), the operation proceeds to step S719 where a determination is made on the received service information.

In step S719, the operation determines whether the operator selected ending of the processing. In a case where the service information is not selected in the own device or the partner device and the operator selects ending of the processing (YES in step S719), the processing is ended. Otherwise, the operation proceeds from step S719 to step S720. When the service information is selected by the own device or the partner device and the selected service information is notified to another party, the service information determining unit 212 determines the service to be used. In step S720, the application management unit 214 activates application program 203, which provides the cooperation service determined by the service information determining unit 212. In step S721, the determined cooperation service is carried out by the activated application program 203, after which the processing is stopped and terminated. As a result of the above operation, the service that the image selected by the digital camera 601 is printed by using the printer 602 is carried out in this case.

In selecting the service information, after the screen of FIG. 10A is displayed and the operator selects the image printing, the options of the application are displayed as it is illustrated in FIG. 10B. When the operator selects the application, the service information is determined. As described above, in a case where the service cannot be determined, it is possible to encourage the user to select the service the user desires.

Alternatively, since the services up to the image printing service can be determined according to a comparison of the degree of the priority, the options of the items which could not be determined may be displayed. In the present exemplary embodiment, as is illustrated in FIG. 10B, the options of the applications for performing the image printing may be displayed. The operations of the user can be simplified by causing the user to select the items that cannot be selected automatically.

In step S709, in a case where there is no corresponding service information which is exchanged between the digital camera 601 and the printer 602 (NO in step S709), the operation of FIG. 7 proceeds to step S711. As in FIG. 8, digital camera 601 and printer 602 each include a service information table and a service list table. In step S711, the service list (of all the services) of the digital camera 601 and the service list of the printer 602 as the partner device are compared to each other. In step S712, the operation determines whether there is corresponding service information that works in cooperation with each other. If the operation determines that there is no corresponding service information that works in cooperation with each other, the processing is stopped and terminated In a case where there is the corresponding service information that works in cooperation with each other (YES in step S712), the operation proceeds to step S713 where the option for selecting the service information is displayed and the operator is urged to select the service. There is a plurality of selecting methods. For example, a list of the corresponding service information is drawn up and the operator is urged to select which service in the list the operator uses. There is another method by which the operator is urged to select the items of the service information that cannot be automatically determined. Since steps after step S713 are identical to what are described above, descriptions about the steps are omitted here.

As described above, without setting all the service setting information necessary for starting the services, the operator can select the image file in the display unit 603 of the digital camera 601 and can print the image file only by bringing the digital camera 601 into contact with the printer 602. Since the degrees of the priorities are used, flexible processing can be made even in a case where there are a plurality of services and applications that can be carried out, a plurality of service setting information, and a plurality of protocols. Further, in a case where the service to be used cannot be automatically determined, the service to be used can be selected by the operator from the services which can be used. In a case where the service to be used can be narrowed down according to the degrees of the priorities of the service information, the operations of the operator can be simplified and the service can be used with a simple operation if a method for urging the operator to select only the items of the service information which cannot be determined automatically is used.

In the present exemplary embodiment, the operator selects service information from the display of the own device to start the cooperation service with the partner device. Then, if the cooperation service with the partner device can be started normally, the operator continues the cooperation service. If the cooperation service with the partner device cannot be started, the operator changes the service to another service to start the cooperation service with the partner device.

A configuration of the system of the present exemplary embodiment has the same configuration as FIG. 6. The configuration of the digital camera 601 may not include the service information transmitting unit 210, the service information receiving unit 211 and/or the service information receiving timer 213 of FIG. 2. The printer 602 only provides a service of image printing using the application #1 203.

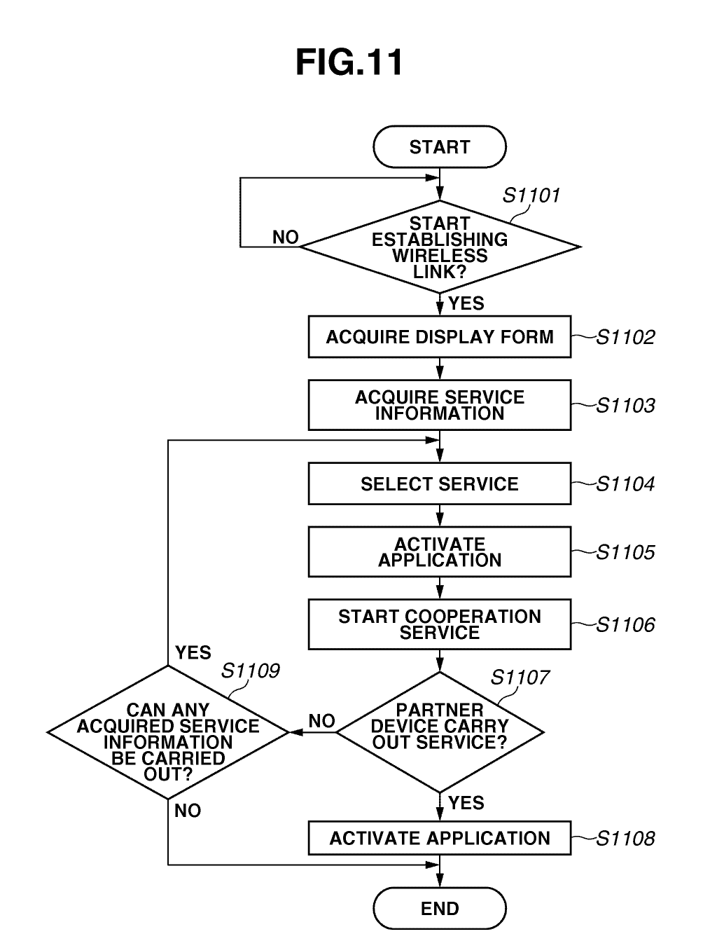

An operation of the present exemplary embodiment is described below with reference to the operational flow chart of FIG. 11. In the following description, the digital camera 601 is dealt with and thus the digital camera 601 is the own device and the printer 602 is the partner device.

In an initial state, the digital camera 601 is placed sufficiently far from the printer 602 such that communication cannot be established between the digital camera 601 and the printer 602 through the proximal wireless communication 605. In a case where the operator desires to print an image file stored in the digital camera 601 by using the printer 602, the operator selects the image file the operator desires to print through the operation of the digital camera 601. Normally, the operator may cause the display unit 603 of the digital camera 601 to display an image of the image file.

In this state, the digital camera 601 is brought closer to the printer 602 so that the digital camera 601 may become a communication partner with the printer 602. In step S1101, the operation determines whether the communication detection unit 207 of the digital camera 601 detects a connection to the proximal wireless communication 105 since the communication detection unit 207 monitors a connection of the proximal wireless communication 605. A purpose of this determination is to start establishing a wireless link. If the communication detection unit 207 does not detect a connection to the proximal wireless communication 105, the operational flow returns to step S1101. In a case where the connection is detected (YES in step S1101), the display control determining unit 215 assesses the display form of the display unit 103 and notifies the determined result to the service information acquisition unit 209. In the example, the operator caused the display unit 603 of the digital camera 601 to display an image of the image file. In step S1102, by the notification from the display control determining unit 215, the service information acquisition unit 209 acquires the display form of the display unit 603 at the time.

As a result of the above, in step S1103, the service information acquisition unit 209 can confirm that the image file is selected in the display form. The service information acquisition unit 209 detects the service information table 208, and acquires from the service information table 208 the service information corresponding to the display form. Since, in this case, an image file is selected in the display, the service information acquisition unit 209 acquires image printing (sending side) and an image transfer (sending side) as the service information (see FIGS. 8 and 9). In other words, the service information acquisition unit 209 looks up “select image file (JPG)” in the Service Information Table of Digital Camera 601 in FIG. 9 to obtain as service information those services that can be carried out based on the “select image file (JPG)” display form.

In step S1104, the operation selects the service information having the highest degree of the priority. In particular, the service information determining unit 212 confirms the degree of the priority of the service information that the service information acquisition unit 209 acquired in step S1103 and selects the service information having the highest degree of the priority. In step S1105, after the service information is selected, the application management unit 214 activates application program 203, which provides a service corresponding to the selected service information. In step S1106, the application management unit 214 starts cooperative service and notifies the start of the service to the partner device by using the activated application program 203. In step S1107, the operation determines whether the partner device carries out the cooperative service started in step S1106. In a case where the partner device does not carry out the above service (NO in step S1107), the service is ended in error since either an error notification or no response returns to the own device from the partner device. At step S1109, the operation determines whether the services corresponding to any service information acquired in step S1103 can be carried out. If the services corresponding to any service information acquired in step S1103 cannot be carried out, the processing is ended. If the services corresponding to any service information acquired in step S1103 can be carried out, that is to say, in a case where the service is ended in error, the operation returns to step S1104 and the service information determining unit 212 re-selects a service having the next highest degree of the priority to perform the processing after step S1105. In steps S1107 and S1108, in a case where the partner device carries out the above service (YES in step S1107), the service is continuously carried out since a normal response returns with respect to the start of the service. In step S1108, the application management unit 214 activates application program, which is determined by the service information determining unit 212 in order to provide the cooperation service started in step S1106.

In the present exemplary embodiment, since the image file is selected in the display of the digital camera 601, the service information acquisition unit 209 acquires image printing (sending side) and an image transfer (sending side) as the service information. The selection of the service information and the start of the service are repeated until the image printing (sending side) using the application #1 203, which the printer 602 can process, is selected. Further, when the image printing (sending side) using the application #1 203 is selected, the image print service is carried out in cooperation with the printer 602.

As described above, according to the present exemplary embodiment, even if the partner device cannot perform the automatic service selection, the service according to an automatic selection based on the display can be carried out.

The features of the present invention can also be achieved by providing a system or apparatus with a computer-readable medium having stored thereon a program containing program code to cause an apparatus to implement functions of the embodiments described above. The program code may be recorded on this computer-readable medium and a computer (CPU or MPU) of the system or apparatus can achieve the functions of the above described embodiments by reading and executing the program code stored on the storage medium. In this case, the functions of the embodiments are implemented by the program code read from the storage medium, so that the storage medium storing the program code falls within the scope of the present invention. The storage medium for supplying the program code may be, for example, a floppy disk, a hard disk, an optical disk, a magneto-optical disk, a CD-ROM, a CD-R, a magnetic tape, a non-volatile memory card, a ROM, and other non-transient storage medium.

Instead of achieving the functions of the embodiments through execution of the program code by a computer, an OS (Operating System) running on the computer may execute part of or the entire processing according to instructions in the program code, thereby achieving the functions of the above described embodiments. This also falls within the scope of the present invention.

Furthermore, the program code read from the storage medium may be written to a memory of a function extension board mounted on the computer or a function extension unit connected to the computer so that a CPU or the like of the function extension board or the function extension unit can execute part of or the entire processing according to the program code, thereby achieving the functions of the embodiments. This also falls within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-144612 filed Jun. 17, 2009, which is hereby incorporated by reference herein in its entirety.

What is claimed is:

1. A communication device, comprising:
a display unit;
a display control determining unit configured to evaluate a display form of the display unit to determine a type of display form;
a selecting unit configured to select a service corresponding to the type of display form determined by the display control determining unit; and
a communication unit configured to establish a communication with a partner device by using the service selected by the selecting unit.

2. The communication device according to claim 1,
wherein the selecting unit is configured to select a plurality of services, and
the communication device further comprises
a service information determining unit configured to determine a service to be used in a communication with the partner device from the plurality of services.

3. The communication device according to claim 2, wherein the service information determining unit is configured to determine a service to be used in the communication with the partner device based on the plurality of services selected by the selecting unit and information relating to the plurality of services received from the partner device.

4. The communication device according to claim 3,
wherein if the communication device receives no information relating to the service from the partner device, the communication unit does not carry out the service and ends the service even if a predetermined time period has lapsed after a connection with the partner device was established.

5. The communication device according to claim 2, wherein the service information determining unit is configured to determine the service which can be carried out in cooperation between the communication device and the partner device, as the service to be used in the communication with the partner device.

6. The communication device according to claim 2, wherein the service information determining unit is configured to determine the service to be used in the communication with the partner device based on a degree of a priority of the service selected by the selecting unit.

7. The communication device according to claim 1, further comprising:
an application management unit configured to manage the service such that the service is related to any one of (i) information relating to an application which provides the service, and (ii) information relating to a communication protocol in carrying out the service, and setting information in carrying out the service,
wherein the selecting unit is configured to select the service corresponding to the display form based on the information managed by the application management unit.

8. The communication device according to claim 1, further comprising:
a display control unit configured to present information in visual form on the display unit to urge an operator to select the service that was selected by the selecting unit.

9. The communication device according to claim 8, wherein the display control unit is configured to present the visual form information on the display unit to urge the operator to select a service in a case where a service used in a communication with the partner device is not automatically determined from the services selected by the selecting unit.

10. The communication device according to claim 1, further comprising:
a communication detection unit configured to detect a connection with the partner device,
wherein the selecting unit is configured to select a service corresponding to a display form presented on the display unit when the communication detection unit detects a connection with the partner device.

11. A communication device, comprising:
a display unit;
a display control determining unit configured to evaluate a display form of the display unit to determine a type of display form;
a selecting unit configured to select a service corresponding to the type of display form determined by the display control determining unit; and
a service information determining unit configured to determine a service to be used in a communication with a partner device from a plurality of services selected by the selecting unit.

12. A method of controlling a communication device, the method comprising:
evaluating, in a display control determining unit, a display form of a display unit to determine a type of display form;
selecting, in a selecting unit, a service corresponding to the type of display form determined in the display control determining unit; and
communicating with a partner device through a communication unit by using the service selected by the selecting unit.

13. A computer-readable storage medium having stored thereon, a program that causes a communication device to perform a method according to claim 12.

14. A method of controlling a communication device, the method comprising:
evaluating, in a display control determining unit, a display form of a display unit to determine a type of display form;
selecting, in a selecting unit, a service corresponding to the type of display form determined in the display control determining unit; and
determining, in a service information determining unit, a service to be used in communicating with a partner device from a plurality of services selected by the selecting unit.

15. A computer-readable storage medium having stored thereon, a program that causes a communication device to perform a method according to claim 14.
